(19) United States
(12) Patent Application Publication
(10) Pub. No.: US 2014/0074635 A1
(43) Pub. Date: Mar. 13, 2014

(54) VIRTUAL POINT OF SALE

(71) Applicants: Kenneth W. Reese, Portland, OR (US); Raviprakash Nagaraj, Tigard, OR (US)

(72) Inventors: Kenneth W. Reese, Portland, OR (US); Raviprakash Nagaraj, Tigard, OR (US)

(21) Appl. No.: 13/976,166

(22) PCT Filed: Dec. 29, 2011
(86) PCT No.: PCT/US11/67782

§ 371 Date: Nov. 21, 2013

(51) Int. Cl. G06Q 20/20; G06Q 20/38; G06Q 20/40

(52) U.S. Cl. CPC G06Q 20/202; G06Q 20/4014; G06Q 20/3821
USPC 705/21; 705/44

(57) ABSTRACT

In one embodiment a controller comprises logic to receive a payment request for a purchase transaction, wherein the payment request comprises transaction information associated with the purchase transaction, present at least a portion of the transaction information on a user interface, receive payment source data from a remote resource, securely wrap the payment source data and transmit the payment source data to a remote device. Other embodiments may be described.

### BACKGROUND

The subject matter described herein relates generally to the field of electronic devices and more particularly to a system and method to implement virtual point of sale transactions using electronic devices.

In a typical online (i.e., consumer not-present) electronic commerce transaction the merchant and underlying ecosystem, is not certain that the individual conducting the transaction is the authorized person. When fraudulent transactions are accepted by the online ecosystem there is an underlying fraud cost that is generally borne by the relying party, in this example the merchant, or by the defrauded individual. A second category of not-present transactions is that of mail order/telephone order or Moto. For these types of transactions face-to-face assurances are also not available, and in addition the fact that humans are generally involved in the transmission of payment credentials creates a greater exposure for theft of those credentials. For this reason the merchant cost for processing credentials obtained in this manner exceeds that of credentials obtained through more secure, traditional means.

Another weakness in the online space is the ever-present threat of system malware, which is often used to steal personal information, including payment credentials, for use by unauthorized individuals. This threat has an effect on a certain percentage of the population who will not conduct online activity due to fear of having their information compromised. This reduces efficiencies that can be gained through online commerce and limits the amount of goods and services purchased by concerned individuals, limiting the growth of online commerce.

Existing solutions to these problems are limited in their usefulness and/or security due to the fact that they are hosted inside the PC operating system, which is always a point of vulnerability, or require external, attached hardware devices, which limit consumer ease-of-use factors. For Moto transactions there are even fewer options available to reduce vulnerabilities inherent in the credential transmission process. Accordingly systems and techniques to provide a secure computing environment for electronic commerce may find utility.

### BRIEF DESCRIPTION OF THE DRAWINGS

The detailed description is described with reference to the accompanying figures.

FIG. 1 is a schematic illustration of an exemplary electronic device which may be adapted to include infrastructure to implement virtual point of sale transactions in accordance with some embodiments.

FIG. 2 is a high-level schematic illustration of an exemplary architecture for virtual point of sale transactions in accordance with some embodiments.

FIG. 3 is a schematic illustration of an exemplary architecture for virtual point of sale transactions accordance with some embodiments.

FIG. 4 is a schematic illustration of an exemplary system for cloud-based credit card emulation, in accordance with some embodiments.

FIG. 5A is a schematic illustration of an interaction between an exemplary electronic device and an exemplary virtual point of sale device in accordance with some embodiments.

FIG. 5B is a schematic illustration of a logical view of virtual point of sale transaction environment, according to embodiments.

FIG. 6 is a flowchart illustrating operations in a method to implement virtual point of sale transactions in accordance with some embodiments.

FIG. 7 is a sequence diagram which illustrates an interaction between an exemplary electronic device and an exemplary virtual point of sale device in accordance with some embodiments.

### DETAILED DESCRIPTION

Described herein are exemplary systems and methods to implement virtual point of sale (VPOS) transactions in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

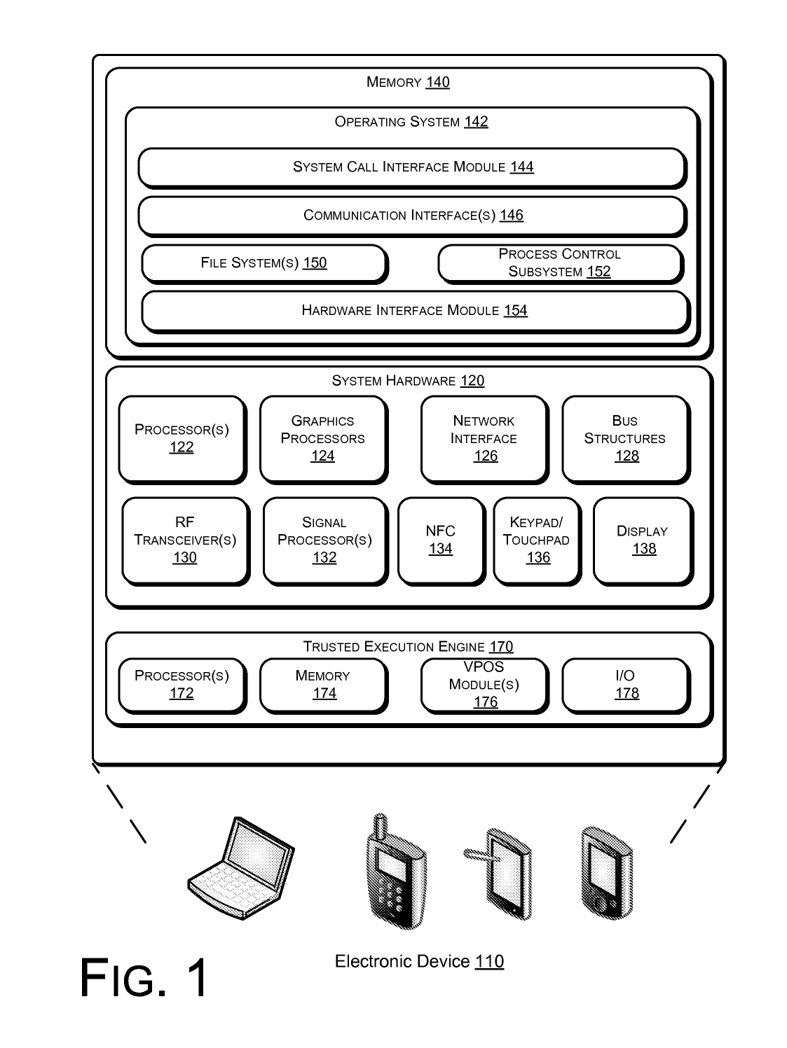

FIG. 1 is a schematic illustration of an exemplary electronic device 110 which may be adapted to implement virtual point of sale transactions in accordance with some embodiments. As illustrated in FIG. 1, electronic device 110 may be embodied as a conventional mobile device such as a mobile phone, tablet computer portable computer, personal digital assistant (PDA), or server computer.

In various embodiments, electronic device 110 may include or be coupled to one or more accompanying input/output devices including a display, one or more speakers, a keyboard, one or more other I/O device(s), a mouse, or the like. Exemplary I/O device(s) may include a touch screen, a voice-activated input device, a track ball, a geolocation device, an accelerometer/gyroscope, biometric feature input devices, and any other device that allows the electronic device 110 to receive input from a user and to assist in providing non-refutable proof that an authorized user was present at the time of transaction.

The electronic device 110 includes system hardware 120 and memory 140, which may be implemented as random access memory and/or read-only memory. A file store may be communicatively coupled to computing device 110. The file store may be internal to computing device 110 such as, e.g., eMMC, SSD, one or more hard drives, or other types of storage devices. File store 180 may also be external to computer 110 such as, e.g., one or more external hard drives, network attached storage, or a separate storage network.

System hardware 120 may include one or more processors 122, graphics processors 124, network interfaces 126, and bus structures 128. In one embodiment, processor 122 may be embodied as an Intel® Atom™ processors, Intel® Atom™ based System-on-a-Chip (SOC) or Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

Graphics processor(s) 124 may function as adjunct processor that manages graphics and/or video operations. Graphics processor(s) 124 may be integrated onto the motherboard of electronic device 110 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI), a High Speed Synchronous Serial Interface (HSI), a Serial Low-power Inter-chip Media Bus (SLIMbus®), or the like.

Electronic device 110 may include an RF transceiver 130 to transceive RF signals, a Near Field Communication (NFC) radio 134, and a signal processing module 132 to process signals received by RF transceiver 130. RF transceiver may implement a local wireless connection via a protocol such as, e.g., Bluetooth or 802.11x. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a WCDMA, LTE, general packet radio service (GPRS) interface (see, e.g., Guidelines on GPRS Handset Requirements, Global System for Mobile Communications/GSM Association, Ver. 3.0.1, December 2002).

Electronic device 110 may further include one or more input/output interfaces such as, e.g., a keypad 136 and a display 138. In some embodiments electronic device 110 may not have a keypad and use the touch panel for input.

Memory 140 may include an operating system 142 for managing operations of computing device 110. In one embodiment, operating system 142 includes a hardware interface module 154 that provides an interface to system hardware 120. In addition, operating system 140 may include a file system 150 that manages files used in the operation of computing device 110 and a process control subsystem 152 that manages processes executing on computing device 110.

Operating system 142 may include (or manage) one or more communication interfaces 146 that may operate in conjunction with system hardware 120 to transceive data packets and/or data streams from a remote source. Operating system 142 may further include a system call interface module 144 that provides an interface between the operating system 142 and one or more application modules resident in memory 130. Operating system 142 may be embodied as a UNIX operating system or any derivative thereof (e.g., Linux, Android, etc.) or as a Windows® brand operating system, or other operating systems.

Electronic device 110 may comprise a trusted execution engine 170. In some embodiments the trusted execution engine 170 may be implemented as an independent integrated circuit located on the motherboard of the electronic device 110, while in other embodiments the trusted execution engine 170 may implemented as a dedicated processor block on the same SOC die, while in other embodiments the trusted execution engine may be implemented on a portion of the processor(s) 122 that is segregated from the rest of the processor(s) using HW enforced mechanisms

In the embodiment depicted in FIG. 1 the trusted execution engine 170 comprises a processor 172, a memory module 174, a virtual point of sale (VPOS) module 176, and an I/O module 178. In some embodiments the memory module 174 may comprise a persistent flash memory module and the virtual point of sale module 176 may be implemented as logic instructions encoded in the persistent memory module, e.g., firmware or software. The I/O module 178 may comprise a serial I/O module or a parallel I/O module. Because the trusted execution engine 170 is separate from the main processor(s) 122 and operating system 142, the trusted execution engine 170 may be made secure, i.e., inaccessible to hackers who typically mount SW attacks from the host processor 122 or H/W attacks through physical tampering with trusted execution engine 170.

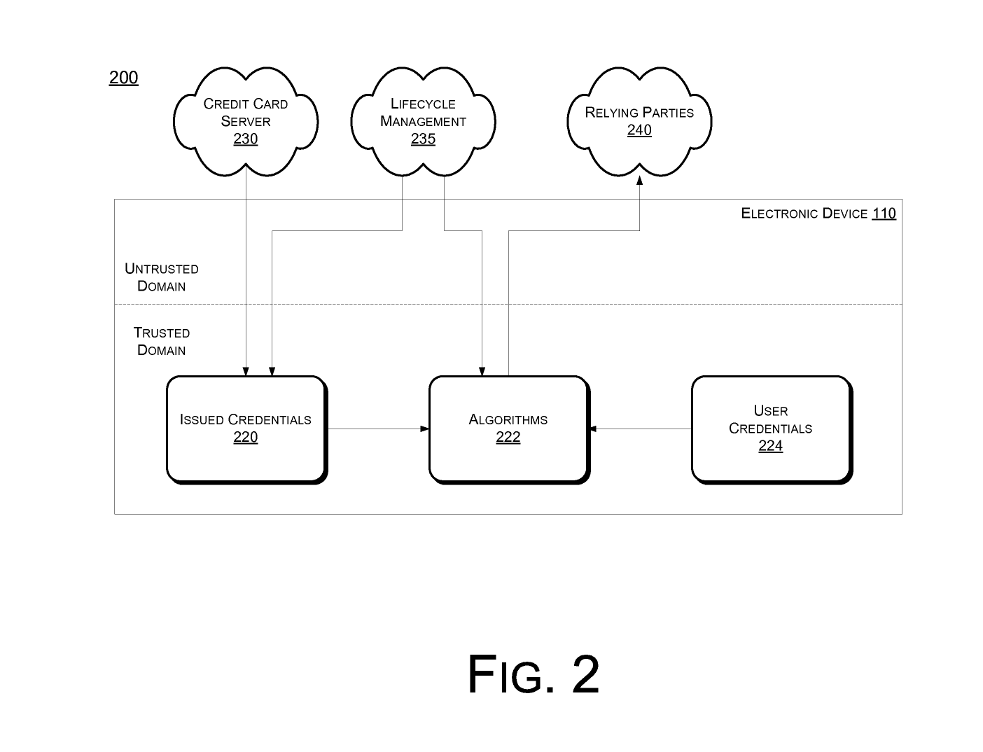

In some embodiments the trusted execution engine may be used to define a trusted domain in a host electronic device in which virtual point of sale procedures may be implemented. FIG. 2 is a high-level schematic illustration of an exemplary architecture for buyer-side virtual point of sale transactions accordance with some embodiments. Referring to FIG. 2, a host device 210 may be characterized as having an untrusted domain and a trusted domain. When the host device 210 is embodied as an electronic device 110 the trusted domain may be implemented by the trusted execution engine 170, while the untrusted domain may be implemented by the main processors(s) 122 and operating system 140 of the system 100. As illustrated in FIG. 2, remote entities that issue credentials, identified as issuers 230 in FIG. 2, supply credentials, which are stored in the trusted domain of the host device 210. In use, the issued credentials and one or more user credentials 224 may be provided as inputs to one or more authentication algorithms 222, which process and validate the user credentials and generate a confirmation token, which may be used to effect release of the payment credential to a VPOS credential acquisition module. Integrity of the trusted domain may be maintained through exclusive, cryptographically-protected, relationships between a trusted domain and entities that are allowed to issue credentials into 220 or lifecycle manage 235 the contents and algorithms 222 of the trusted domain.

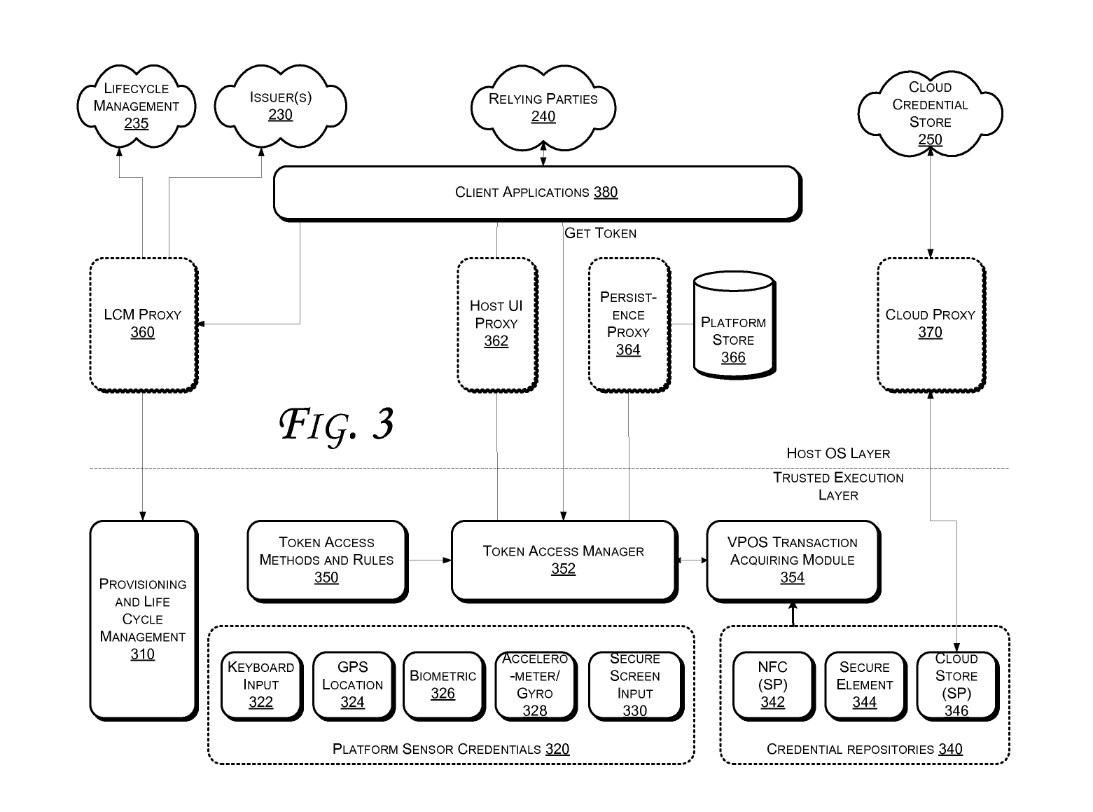

FIG. 3 is a schematic illustration in greater detail of an exemplary architecture for virtual point of sale transactions accordance with some embodiments. In the embodiment depicted in FIG. 3, the trusted execution layer comprises a provisioning and life cycle management module 310, a platform sensor credentials module 320, and a set of credential repositories 340. A token access manager module 352 accepts as inputs one or more token access methods and rules 350 stored in the trusted execution layer. A virtual point of sale transaction acquiring module 354 provides algorithms to acquire and tokenize transactions, wrap the transaction data in an encrypted packet for secure transport to a processing entity, and to publish digital receipts confirming transaction execution.

In the embodiment depicted in FIG. 3 the platform sensor credential may comprise one or more of a secured keyboard input path credential 322, a GPS location credential, a biometric credential 326, an accelerometer or gyroscope credential 328, or a malware-interception-resistant secure screen input mechanism credential 330. The sensor credentials provide a means to securely capture features indicating that the owner of the payment credential is present at the time of transaction. The credential repositories 340 may comprise a NFC input device 342, one or more secure elements 344, and a cloud credential store access mechanism 346. The repository is the medium from which the payment credential is sourced. The combination of a payment credential that you have in the credential repository 340 and an additional authenticating factor supplied via platform sensor credentials 320 yields a 2-factor assertion, commensurate with face-to-face transactions that require either a PIN or signature to authenticate the credential owner.

The untrusted execution layer (i.e., the Host Operating System layer) implements a series of proxies to facilitate communication with the trusted execution layer components. Thus, the untrusted execution layer maintains a life cycle management proxy 360 to facilitate communicate between the provisioning and life cycle management module 310 and remote issuers 230 of credentials, and entities delegated to securely manage 235 the trusted execution layer. Similarly, a host proxy 362 facilitates communication between one or more client applications 380 which execute in the untrusted execution layer and the token access manager 352. A persistence proxy 364 provides a communication link between the token access manager 352 and a platform data store 366. A cloud proxy 370 provides a communication link between cloud credential stores 250 and the cloud store access mechanism 346. For VPOS applications a family of client applications 380 is dedicated to serving either buyer or merchant user interface elements of transactions. For buyer applications the client application provides the user interface to select payment credentials, authenticate the user to the selected credential, and provides methods to view digital receipts generated during VPOS transactions. Similarly, for mobile merchant VPOS applications block 380 provides user interfaces to allow the merchant to configure transaction parameters and to disposition acquired transactions to the appropriate payment acquirer.

In use, the system may obtain credentials from a variety of sources. For example, issuers 230 may issue credentials to the system via the LCM proxy 360. Issued credentials may include dynamic cryptogram (OTP) generation seeds, user certificates (e.g., x509 certificates with public/private key pairs), financial information (e.g., credit card information), bank card information, or the like. Issued credentials may be stored in one or more of the credential repositories 340. By contrast, the platform sensor credentials 320 may be obtained from the user in response to requests from a relying party, either in real time during an authentication process or in advance. One skilled in the art will recognize that platform sensor credentials may be requested indirectly as the result of the relying party asking for other credential, as described below, or even directly by a relying party. By way of example, biometric signatures may be cataloged for users, allowing a centrally-run authentication verification system. Using embodiments described herein, a relying party could ask the platform for a fingerprint credential. The platform would obtain this credential using its fingerprint acquisition hardware, and would return this information to the requesting/relying party.

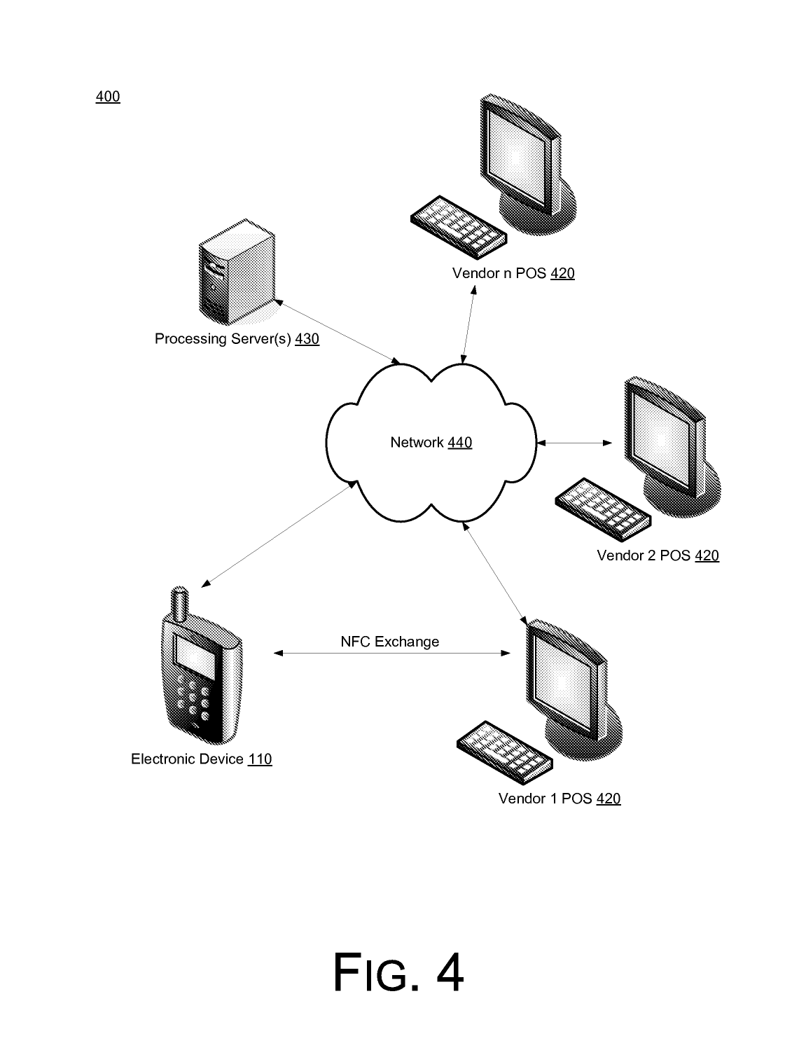

FIG. 4 is a schematic illustration of a system for virtual point of sale transactions according to some embodiments. Referring to FIG. 4, an electronic VPOS client device 110 may be coupled to one or more merchant VPOS point of sale devices 420, either directly via a near field communication (NFC) capability or via a network 440. In some embodiments the NFC capability may comprise a near-field wireless communication link, e.g., a Bluetooth link, an infrared like, or the like.

Merchant VPOS Point of sale devices 420 may be coupled one or more transaction processing servers 430 via network 440 and may comprise a NFC interface to enable wireless communication with electronic device 110. In some embodiments electronic device 110 may be embodied as a mobile telephone, tablet, PDA or other mobile computing device as described with reference to electronic device 110, above. Network 440 may be embodied as a public communication network such as the Internet or Public Switched Telephone Network (PSTN), or as a private communication network, or combinations thereof. POS device 420 may also be embodied as a mobile telephone, tablet, PDA, personal computer, server, or other computing device as described with reference to electronic device 110, above.

Servers 430, may be embodied as computer systems. In some embodiments the server 430 may be embodied as a payment processing server and may be managed by a vendor or by a third party which operates secure platform. Payment server(s) 432 may be operated by a vendor or by a third-party payment system, e.g., a transaction clearing service or a credit card service.

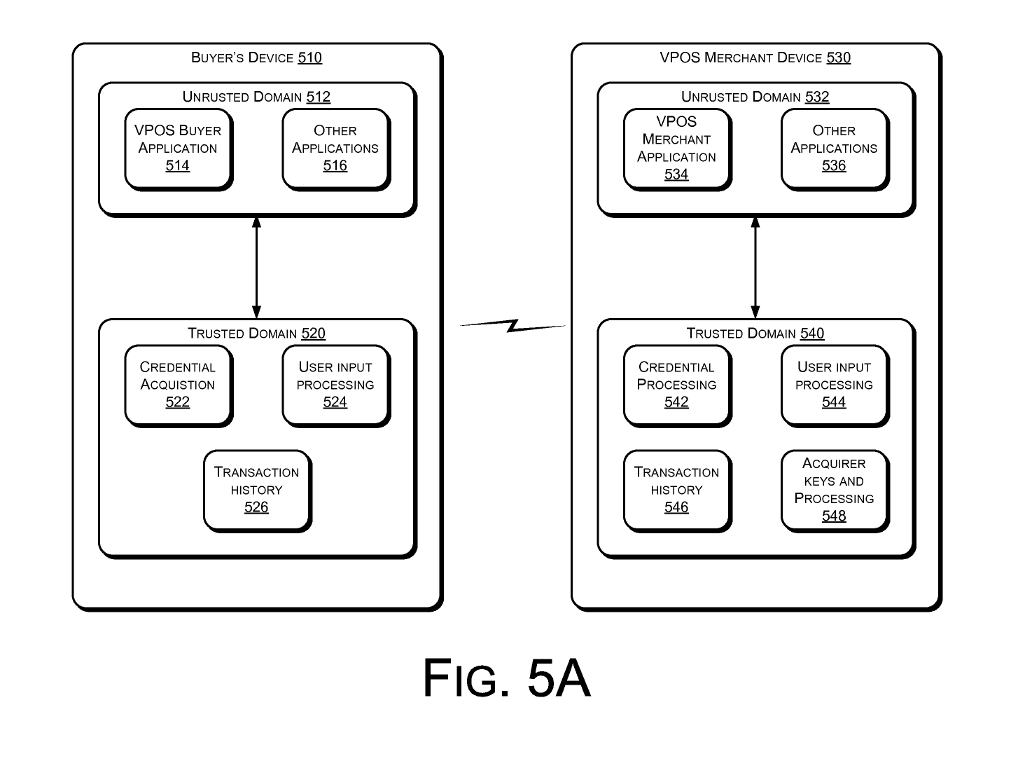

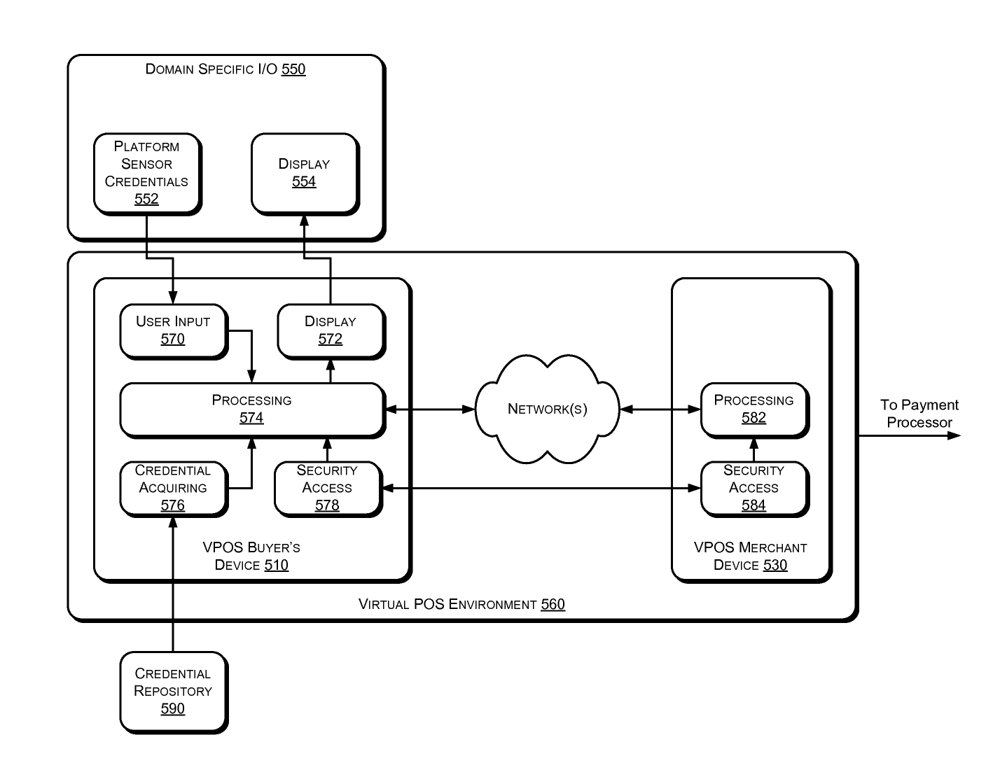

FIG. 5A is a schematic illustration of an interaction between an exemplary virtual point of sale client electronic device and an exemplary merchant virtual point of sale device in accordance with some embodiments. Referring to FIG. 5A, in some embodiments a buyer's device 510 comprises an untrusted domain and a trusted domain. The untrusted domain 512 may execute on the operating system of the buyer's device while the trusted domain 520 may execute on a trusted execution engine 170 as described with reference to FIG. 1, above. The untrusted domain 512 may comprise a virtual point of sale buyer application 514 and one or more other applications 516, e.g., a web browser or the like. The trusted domain 520 may comprise a credential acquisition module 522, a user input processing module 524, and a transaction history module 526.

Similarly, a virtual point of sale merchant device 530 comprises an untrusted domain and a trusted domain. The untrusted domain 532 may execute on the operating system of the merchant's device while the trusted domain 540 may execute on a trusted execution engine 170 as described with reference to FIG. 1, above. The untrusted domain 532 may comprise a virtual point of sale merchant application 534 and one or more other applications 536, e.g., a web browser or the like. The trusted domain 540 may comprise a credential processing module 542, a user input processing module 544, and a transaction history module 546, and an acquirer keys and processing module 548.

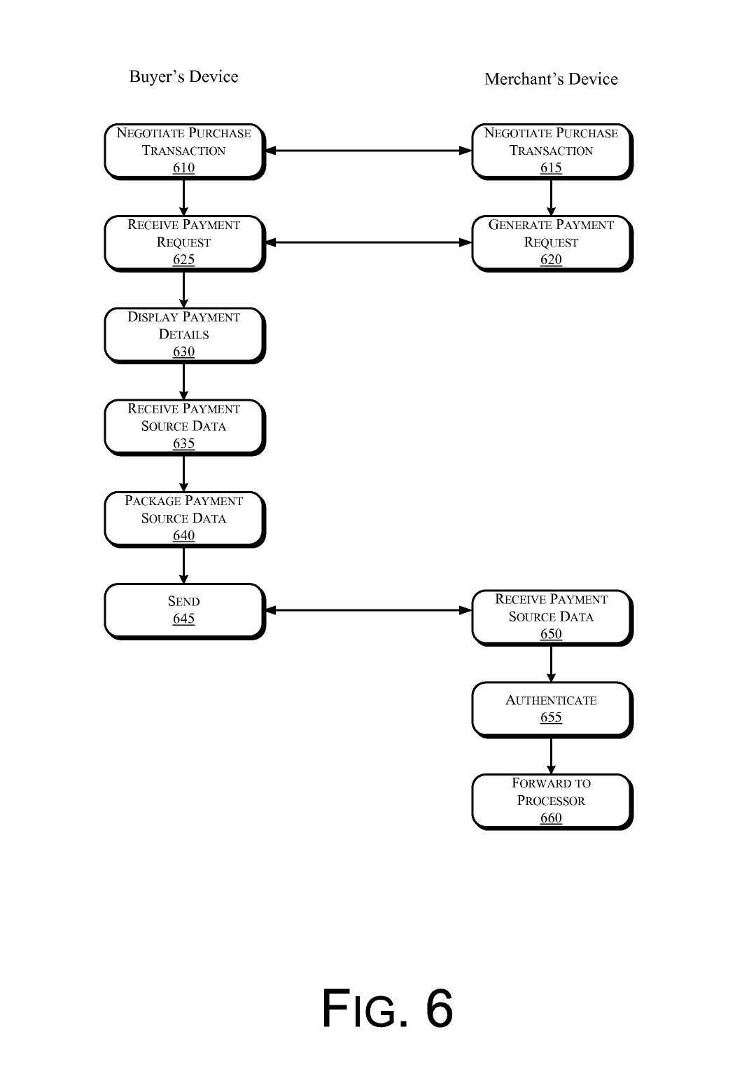

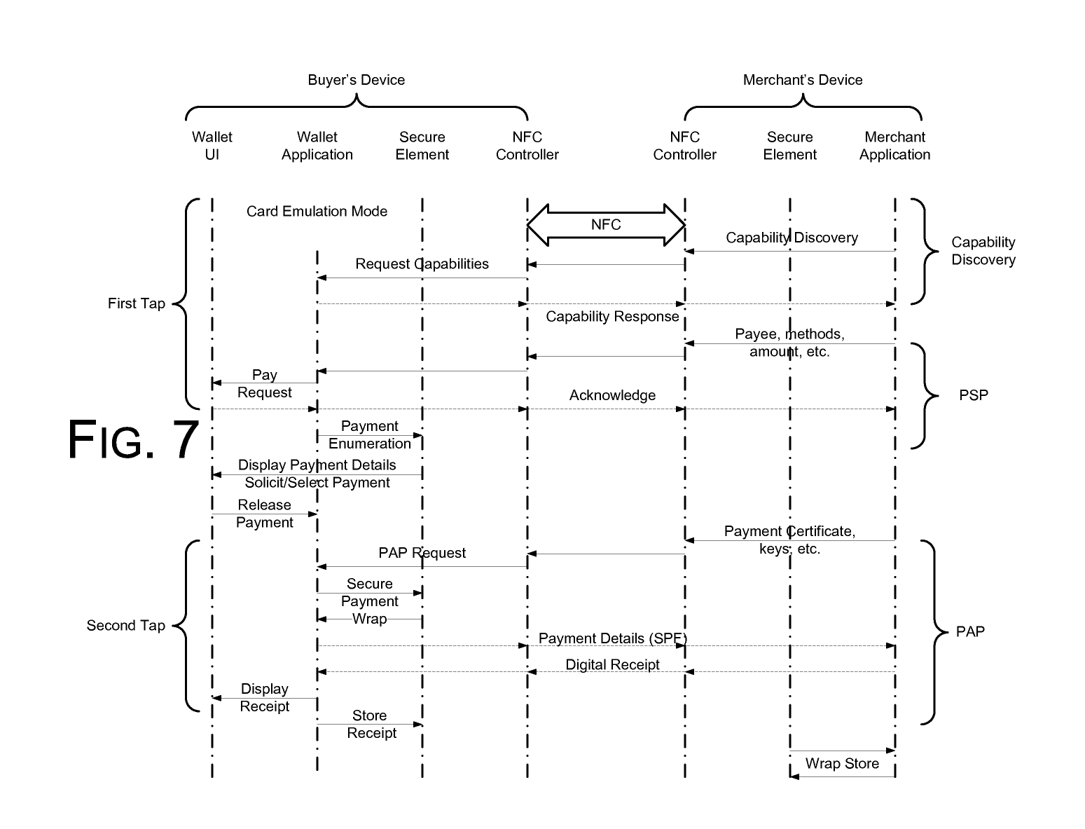

Having described various structures of systems for virtual point of sale transactions, operating aspects of such systems will be explained with reference to FIG. 5B, which is a schematic illustration of a logical view of virtual point of sale transaction environment, according to embodiments, and FIGS. 6-7, which are flowcharts illustrating operations in a method to implement virtual point of sale transactions in accordance with some embodiments. Referring first to FIG. 5B, in a virtual point of sale environment 560 a buyer's device 510 communicates with a merchant device 530 via one or more networks. A domain specific input/output 550 module may include one or more platform sensor credential modules 552 such as, e.g., a keypad or the like to input credentials and a display module 554 to present output. Input from the platform sensor credentials 552 is directed to a user input module 570. Credentials from a credential repository, e.g., a credit card 590 or the like, are input to a credential acquiring module 576. Buyer's device 510 further comprises a display module 572, a processing module 574, and a security access module 578. The merchant's device 530 comprises a processing module 582, and a security access module 584.

In operation, the buyer's device 510 and the merchant device 530 may be communicatively couple by one or more networks. In operation, one or more credentials acquired from the credential repository 590 and platform sensor credentials are input to the processing module 574. The respective security access modules 578, 584 may exchange or pre-share security credentials, which may be provided to the processing modules 574, 582. Shared security credentials are utilized by processing modules 574 and 582 to exchange encrypted or tokenized payment credentials over network 440.

In some embodiments the operations depicted in the flowchart of FIGS. 6-7 may be implemented by the various virtual point of sale modules module(s) 176 of the trusted execution engine 170 depicted in FIG. 1, alone or in combination with software modules which may execute on the operating system of an electronic device.

Referring first to FIG. 6, in some embodiments the operations depicted in FIG. 6 enable a user to implement a virtual point of sale transaction with a merchant. In some embodiments the buyer's device may be embodied as a handheld computing device comprising a trusted execution engine as depicted in FIGS. 1-5. Similarly, a merchant device may be embodied as a computing device comprising a trusted execution engine as depicted in FIGS. 1-5A. Referring to FIG. 6, at operations 610 and 615 a purchase transaction is negotiated between a buyer's device and a merchant's device. The particular devices and negotiation medium are not critical. In some embodiments the purchase transaction may be negotiated by telephone, while in other embodiments the purchase transaction may be negotiated via a web browser on the Internet, while in yet another embodiment the purchase transaction between buyer and seller may be electronically negotiated in person via near field communications technology. By way of example, referring to FIG. 5A in some embodiments the buyer's device 510 may comprise a virtual point of sale buyer application 514 and the merchant device 550 may comprise a virtual point of sale merchant application 534.

Once the purchase negotiation is concluded the member device generates (operation 620) a payment request, which is transmitted to the buyer's device. In some embodiments the payment request may comprise information pertaining to the purchase transaction, e.g., one or more product codes, prices, payment options, delivery methods, or the like. In some embodiments the payment request may be generated by the virtual point of sale merchant application 534 and transmitted to the buyer's device via suitable communication medium. At operation 625 the buyer's device receives the payment request from the merchant's device, and at operation 630 the buyer's device displays one or more payment details received from the merchant's device.

At operation 635 the buyer's device receives payment source data. In some embodiments operation 635 is executed by the trusted domain 520 of the buyer's device. For example, the user input processing module 524 may collect user input from a user interface of the buyer's device 510. The input is collected directly in the trusted execution module and is not accessible to the untrusted domain. The user's payment source data may be collected by the credential acquisition module 522.

At operation 640 the payment source data collected by the buyer's device 510 is packaged and may be encrypted, and at operation 645 the payment data is sent to the merchant's device via a suitable communication medium. At operation 650 the merchant's device receives the payment data. In some embodiments the payment data may be received directly in the trusted domain 540 of a merchant's device and is not accessible to the untrusted domain 532 of the merchant's device.

At operation 655 the payment data received in the merchant's device is authenticated, and in cases where payment source data is encrypted by 640 it is decrypted, and at operation 660 the authenticated payment data may be forwarded to a payment processor.

In some embodiments a merchant may encapsulate virtual point of sale logic into an artifact which may be embedded into a web page. The artifact may be initiated by the user and provides connectivity between the buyer's display/input logic and the merchant's processing logic. In such embodiments the buyer would present a payment instrument via the artifact.

In some embodiments methods to implement virtual point of sale transactions may utilize near field communication (NFC) capabilities of devices, alone or in combination with network-based payment capabilities, to implement virtual point of sale transactions. By way of example, virtual point of sale transactions may be implemented between a buyer's device 510 and a merchant device 530 using near field communication capabilities of the respective devices. By way of example, in some embodiments the respective devices 510, 530 may be equipped with a wireless communication capability, e.g., Bluetooth or the like, and internal devices such as an accelerometer to detect when the device is tapped.

FIG. 7 is a sequence diagram which illustrates an interaction between an exemplary electronic device and an exemplary virtual point of sale device in accordance with some embodiments. Referring to FIG. 7, a virtual point of sale transaction may be initiated between a buyer's device 510 and a merchant's device 530, for example, by tapping the buyer's device and the merchant device. In response to a first tap a merchant application may generate a capability discovery request which may be passed to a near field communication controller in the merchant device, and then to the buyer's device via a near field communication capability. The buyer's device receives the capabilities request in it's near field communication controller and passes the request to a wallet application which may execute in the trusted domain 540 of the device. The wallet application extracts the capabilities and returns them to the merchant application. In response, the merchant application forwards purchase transaction information to the buyer's device via the near field communication capability.

The buyer's device receives the purchase transaction information and initiates a pay request, which may be displayed to the purchaser via a wallet user interface. The wallet user interface generates an acknowledgment which is transferred back to the merchant application. Further, the wallet application may generate and forward a payment enumeration message to a secure element on the buyer's device. The secure element lists available payment options on a display and solicits a payment choice from a user of the device, which information is forwarded to the wallet user interface. If the payment source is approved then the wallet user interface transmits a message to the wallet application to approve release payment of the funds for the transaction.

A user may confirm the purchase transaction with the merchant device, e.g., by initiating a second tap of the buyer's device on the merchant's device. In response to the second tap the merchant's device generates a payment certificate which may include one or more encryption keys. The payment certificate is transmitted to the wallet application on the buyer's device. The wallet application forwards the secure payment details to the trusted execution environment which securely wraps, using payment certificate encryption, the payment details and returns them to the wallet application.

The wallet application forwards the payment details to the merchant application on the merchant's device, which replies with a digital receipt. The digital receipt may be displayed and stored on the secure element of the buyer's device for later retrieval and viewing.

Thus, there is described herein an architecture and associated methods to implement virtual point of sale transactions in electronic devices. In some embodiments the architecture uses hardware capabilities embedded in an electronic device platform to provide assurances to transaction-authorizing parties that a transaction is being made by an authorized individual. In the embodiments described herein authentication, credential acquisition, and persistence are based processing that occurs within a trusted environment, separate from the host operating system. The execution environment may be implemented in a trusted execution engine, which obtains the transaction credentials and which also obtains an acceptable form of user identity that is associated with the obtained credential. The execution environment also applies an appropriate identity verification scheme associated with the credential so as to create the assertion necessary to demonstrate authorized user presence at the time of transaction. In some instances this assertion may be generated within the trusted execution environment or by the credential itself, the latter being the case with certain secure element-based credentials. In other instances the identity captured by the trusted execution environment is sent to the credential issuer for online identity verification. In each of these cases the trusted execution environment provides the merchant an assertion indicating that the transaction is being made by an authorized individual. The trusted execution environment may also provide other elements required to satisfy transaction requirements. In some embodiments the trusted execution engine may be implemented in a remote or attachable device, e.g., a dongle,

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

1-30. (canceled)

31. A controller comprising logic to:
receive a payment request for a purchase transaction, wherein the payment request comprises transaction information associated with the purchase transaction;
present at least a portion of the transaction information on a user interface;
receive payment source data from a remote resource;
securely wrap the payment source data; and
transmit the payment source data to a remote device.

32. The controller of claim 31, wherein the logic comprises a credential acquisition module to acquire one or more payment credentials for the purchase transaction.

33. The controller of claim 31, further comprising logic to receive and process user input.

34. The controller of claim 31, further comprising logic to store at least a portion of the transaction information in a secure memory location.

35. The controller of claim 32, wherein a credential comprises at least one of an input on a secured keyboard input path, a global positioning system (GPS) location, a biometric parameter, an accelerometer, a gyroscope, or a malware-interception-resistant graphical pass code input mechanism.

36. The controller of claim 31, further comprising a secure memory module to store and access credentials.

37. The controller of claim 31, further comprising logic to communicate with a remote device using a near field communication capability.

38. An electronic device, comprising:
a processor to execute an operating system which is to implement an untrusted computing environment; and
a controller, comprising:
a memory;
logic to:
receive a payment request for a purchase transaction, wherein the payment request comprises transaction information associated with the purchase transaction;
present at least a portion of the transaction information on a user interface;
receive payment source data from a remote resource;
securely wrap the payment source data; and
transmit the payment source data to a remote device.

39. The electronic device of claim 38, further comprising logic to receive and process user input.

40. The electronic device of claim 38, further comprising further comprising logic to receive and process user input.

41. The electronic device of claim 38, further comprising logic to store at least a portion of the transaction information in a secure memory location.

42. The electronic device of claim 38, wherein the credential comprises at least one of an input on a secured keyboard input path, a global positioning system (GPS) location, a biometric parameter, an accelerometer, a gyroscope, or a malware-interception-resistant graphical pass code input mechanism.

43. The electronic device of claim 38, further comprising a secure memory module to store and access credentials.

44. The electronic device of claim 38, further comprising logic to communicate with a remote device using a near field communication capability.

45. A computer program product comprising logic instructions stored on non-transitory computer readable medium which, when executed by a processor, configure the processor to:
receive a payment request for a purchase transaction, wherein the payment request comprises transaction information associated with the purchase transaction;
present at least a portion of the transaction information on a user interface;
receive payment source data from a remote resource;
securely wrap the payment source data; and
transmit the payment source data to a remote device.

46. The computer program product of claim 45, further comprising logic instructions stored on non-transitory computer readable medium which, when executed by a processor, configure the processor to receive and process user input.

47. The computer program product of claim 45, further comprising logic instructions stored on non-transitory computer readable medium which, when executed by a processor, configure the processor to receive and process user input.

48. The computer program product of claim 45, further comprising logic instructions stored on non-transitory computer readable medium which, when executed by a processor, configure the processor to store at least a portion of the transaction information in a secure memory location.

49. The computer program product of claim 45, wherein the credential comprises at least one of an input on a secured keyboard input path, a global positioning system (GPS) location, a biometric parameter, an accelerometer, a gyroscope, or a malware-interception-resistant graphical pass code input mechanism.

50. The computer program product of claim 45, further comprising a secure memory module to store and access credentials.

51. The computer program product of claim 45, further comprising logic instructions stored on non-transitory computer readable medium which, when executed by a processor, configure the processor to communicate with a remote device using a near field communication capability.

52. A point of sale device, comprising:
an input interface;
a communication interface;
a processor; and
logic to:
receive purchase transaction information for a purchase transaction;
generate a payment request for the purchase transaction;
transmit the payment request to a remote electronic device;
receive, from the remote electronic device, payment source data for the purchase transaction;
authenticate the payment source data; and
forward the payment source data to a remote payment processor.

53. The point of sale device of claim 52, further comprising logic to:
detect an input from a remote device via a near field communication capability controller;
in response to the input, generate a capability discovery request for the remote device; and
forward the input to the remote device via the near field communication capability controller.

54. The point of sale device of claim 53, wherein the input comprises physical contact between the point of sale device and the remote device.

55. The point of sale device of claim 52, wherein the payment request comprises information describing the payee, a payment balance, and acceptable payment methods.
